(19) United States
(12) Patent Application Publication
(10) Pub. No.: US 2025/0193990 A1
(43) Pub. Date: Jun. 12, 2025

(54) Multi-Pulse Flash X-ray for Pulsed X-ray Cineradiography

(71) Applicant: U.S. Army DEVCOM, Army Research Laboratory, Adelphi, MD (US)

(72) Inventors: Michael B. Zellner, North East, MD (US); Willard C. Uhlig, Bel Air, MD (US); Paul R. Berning, Havre de Grace, MD (US)

(21) Appl. No.: 18/531,850

(22) Filed: Dec. 7, 2023

(51) Int. Cl. H05G 1/20; G01N 23/04

(52) U.S. Cl. CPC H05G 1/20; G01N 23/04; G01N 2223/304

(57) ABSTRACT

A pulse sequencer that generates multiple X-ray pulses via a single X-ray tube is described. The pulse sequencer may include multiple pulse generators arranged in parallel. The parallel pulse generators may be multiplexed to the X-ray tube. Each pulse generator may include an energy source and a switch and may be connected to an isolation diode. Each switch may be closed in a sequence to generate multiple pulses. The isolation diodes may isolate each pulse generator from other pulse generators. Each isolation diode may include various features to reduce recovery time. After firing a pulse generator, the associated diode may be temporarily shorted by plasma created within the isolation diode during pulse generation. Each isolation diode may include a set of one or more magnets that may be used to clear the plasma and reduce recovery time such that pulse frequency may be increased.

### GOVERNMENT INTEREST

The invention described herein may be manufactured, used and licensed by or for the U.S. Government.

### FIELD OF THE INVENTION

The invention described herein is related to pulsed X-ray cineradiography.

### BACKGROUND OF THE INVENTION

Existing multi-pulse solutions arrange multiple X-ray tubes arranged as close as possible to achieve multiple pulses near a particular location. Such an approach results in offsets between pulses that may distort or obscure portions of an X-ray.

Therefore, there is a need for a multi-pulse flash X-ray that is able to provide multiple pulses via a single X-ray tube.

### BRIEF SUMMARY OF THE INVENTION

A pulse sequencer of some embodiments may be able to generate multiple X-ray pulses via a single X-ray tube. The pulse sequencer may include multiple pulse generators arranged in parallel. The parallel pulse generators may be multiplexed to the X-ray tube.

Each pulse generator may include an energy source (e.g., a charged capacitor) and a switch. Each switch may be closed in a sequence to generate a series of pulses. Isolation diodes may isolate each pulse generator from other pulse generators.

Each isolation diode may include various features to reduce recovery time for the isolation diode. After firing a pulse generator, the associated diode may be temporarily shorted by plasma (a medium of unbound positive and negative particles) created within the isolation diode during pulse generation. Other pulse generators may not be fired until the plasma is cleared, and the isolation diode regains functionality.

Each isolation diode may include a set of one or more magnets that may be used to clear the plasma and reduce recovery time such that pulse frequency may be increased. Such plasma-clearing magnets may improve performance, such as by decreasing the delay between pulses.

### BRIEF DESCRIPTION OF THE DRAWINGS

The novel features of the disclosure are set forth in the appended claims. However, for purpose of explanation, several embodiments are illustrated in the following drawings.

FIG. 1 illustrates an example overview of one or more embodiments described herein, in which a pulse sequencer produces multiple X-ray pulses via a single X-ray tube;

FIG. 2 illustrates an example overview of one or more embodiments described herein, in which a first X-ray pulse of a multi-pulse X-ray is fired;

FIG. 3 illustrates an example overview of one or more embodiments described herein, in which a first isolation diode is shorted and a second pulse of the multi-pulse X-ray cannot be fired;

FIG. 4 illustrates an example overview of one or more embodiments described herein, in which a second X-ray pulse of a multi-pulse X-ray is fired;

FIG. 5 illustrates a left side elevation view of an isolation diode of one or more embodiments described herein;

FIG. 6 illustrates a front elevation view of the isolation diode of FIG. 5;

FIG. 7 illustrates a front elevation view of an isolation diode of one or more embodiments described herein;

FIG. 8 illustrates a flow chart of an exemplary process that generates a sequence of pulses; and

FIG. 9 illustrates a schematic block diagram of one or more exemplary devices used to implement various embodiments.

### DETAILED DESCRIPTION OF THE INVENTION

The following detailed description describes currently contemplated modes of carrying out exemplary embodiments. The description is not to be taken in a limiting sense, but is made merely for the purpose of illustrating the general principles of some embodiments, as the scope of the disclosure is best defined by the appended claims.

Various features are described below that can each be used independently of one another or in combination with other features. Broadly, some embodiments generally provide a pulse sequencer that provides multi-pulse flash X-ray capability.

Such multi-pulse flash X-ray solutions may be utilized to analyze materials and/or otherwise collect information. For example, the multi-pulse flash X-ray solutions of some embodiments may be utilized to analyze material performance in response to ballistics events where debris, smoke, etc. may form an obscurant cloud.

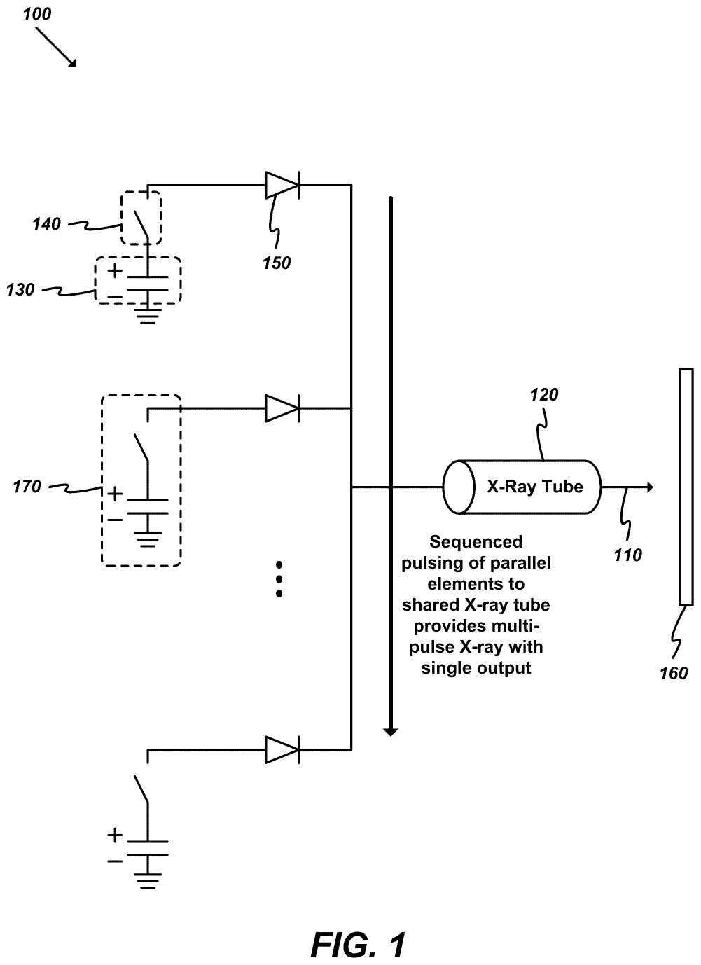

FIG. 1 illustrates an example overview of one or more embodiments described herein, in which a pulse sequencer 100 produces multiple X-ray pulses 110 via a single X-ray tube 120. As shown, pulse sequencer 100 may include multiple capacitors 130, multiple switches 140, multiple diodes 150, one or more X-ray detectors, cameras, and/or other sensors 160, X-ray tube 120, and/or other appropriate components (e.g., a controller that is able to at least partly direct the operation of other components 120-150 of the pulse sequencer 100, optical components such as collimators, cameras and/or other sensors, a housing, etc.).

A pulse generator 170 may include a capacitor 130 and a switch 140 arranged in series as shown. Each pulse generator 170 may be connected to an isolation diode 150 in series as shown. Multiple pulse generators 170 (and associated isolation diodes 150) may be combined in parallel, as shown, in order to generate multiple pulses to feed X-ray tube 120. In this example, three pulse generators 170 (and three associated isolation diode 150) are shown, however, the pulse sequencer 100 may include any number of such pulse generators 170 and associated isolation diodes 150.

Pulse sequencer 100 may be, include, utilize, and/or be implemented via one or more electronic devices, components, and/or systems. For example, pulse sequencer 100 may be included as part of an X-ray machine. Pulse sequencer 100 may include, utilize, and/or be implemented using one or more devices such as device 900 described below.

X-ray pulse 110 may be a light pulse generated by X-ray tube 120. The light pulse may pass through and/or around various subjects including various materials, and be received at a camera or other appropriate sensor (not shown).

X-ray tube 120 may be an electronic device that is able to convert electrical power into X-ray radiation. X-ray tube 120 may be, include, and/or utilize a vacuum tube with a cathode, anode, various connectors and/or conductors, and a housing or envelope (e.g., copper, glass, etc.).

Each capacitor 130 (or “capacitive source”) may include multiple capacitive elements arranged in such a way as to store an appropriate amount of charge (e.g., several hundred thousand kilovolts, where each capacitor 130 may have a capacity of five hundred kilovolts or more). Each capacitor 130 may be, include, and/or utilize a “Marx generator” where a number of capacitors are charged in parallel and then suddenly connected in series to generate a pulse.

Each switch 140 may be a controllable element that is able to selectively connect each capacitor 130 to each isolation diode 150. In some embodiments, each switch 140 may be integrated with and/or at least partly controlled by a Marx generator, such that the switch 140 is closed when a pulse is generated.

Each isolation diode 150 may be a two-terminal electronic component that conducts current in one direction and blocks current in an opposite direction. Various specific structures described in more detail below may form at least a portion of each isolation diode 150. In some embodiments, each isolation diode 150 may be, include, or utilize an X-ray tube 120.

Some embodiments of the pulse sequencer 100 may include other isolating elements in place of isolation diodes 150. For example, in some embodiments, exploding wire diodes may be used in place of isolation diodes 150 in a similar arrangement as shown. Such exploding wire diodes may act as fuses that must be replaced or reset between each pulse generation sequence.

Each X-ray detector 160 may be, include, and/or utilize elements such as a tungsten plate or target, one or more cameras, other types of X-ray sensors, etc. that may be able to measure received X-ray radiation in order to generate an X-ray image. The X-ray detector 160 may be located and/or arranged relative to the X-ray tube 120 such that a face or surface of the X-ray detector 160 is aligned with the X-ray pulses 110 (e.g., a surface of the X-ray detector may be perpendicular to an axis that is parallel to X-ray pulse 110) and/or otherwise captures at least a portion of the X-ray radiation emitted via the X-ray pulse 110.

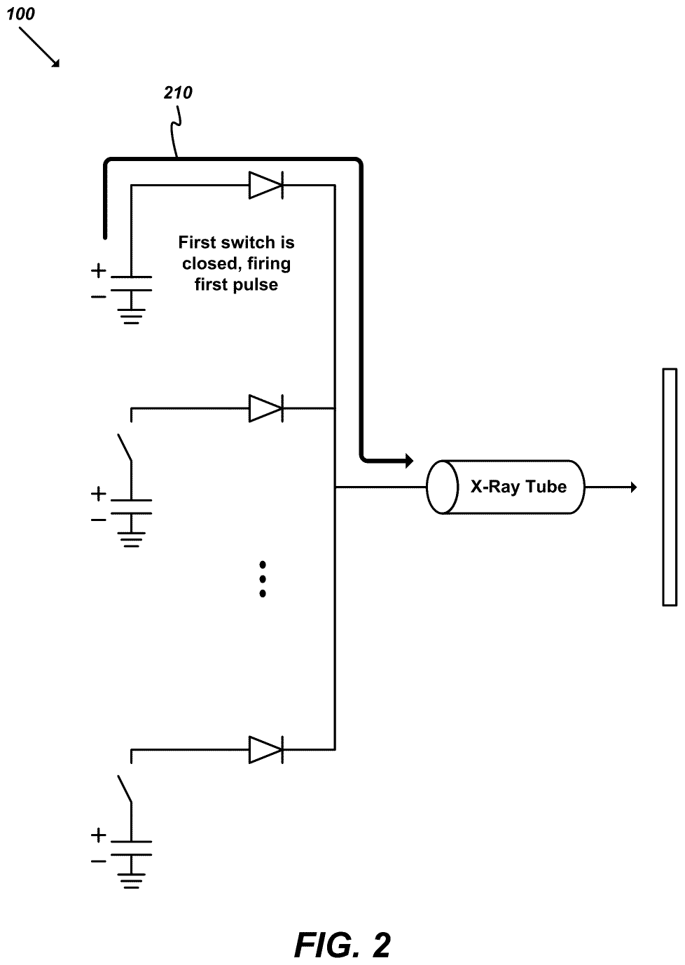

FIG. 2 illustrates an example overview of one or more embodiments described herein, in which a first X-ray pulse 110 of a multi-pulse X-ray is fired. In this example, a first pulse may be generated by the first pulse generator 170 at the top of the page and be supplied to the X-ray tube 120 via first pulse path 210 (including associated isolation diode 150). As shown, the first switch 140 may be closed, releasing the stored charge at the first capacitor 130, and a first pulse may be fired via the first isolation diode 150 and the X-ray tube 120, generating a first X-ray pulse 110.

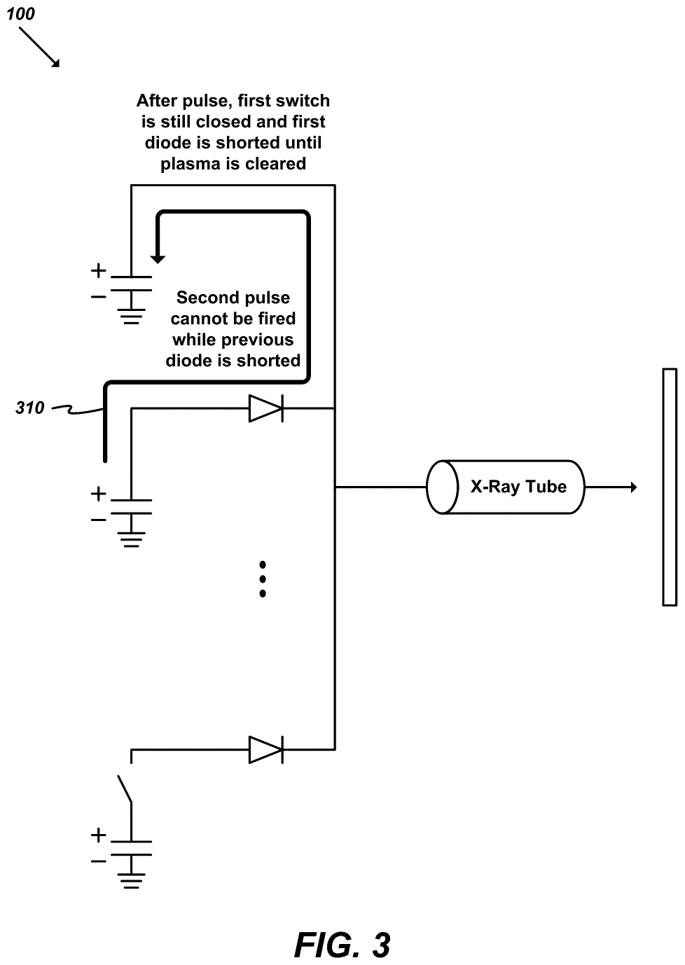

FIG. 3 illustrates an example overview of one or more embodiments described herein, in which a first isolation diode 150 is shorted and a second pulse of the multi-pulse X-ray cannot be fired. As shown, the shorted isolation diode 150 may allow the output of the second pulse generator 170 to be at least partially absorbed by the first capacitor 130 via parasitic path 310 rather than being transmitted fully to the X-ray tube 120.

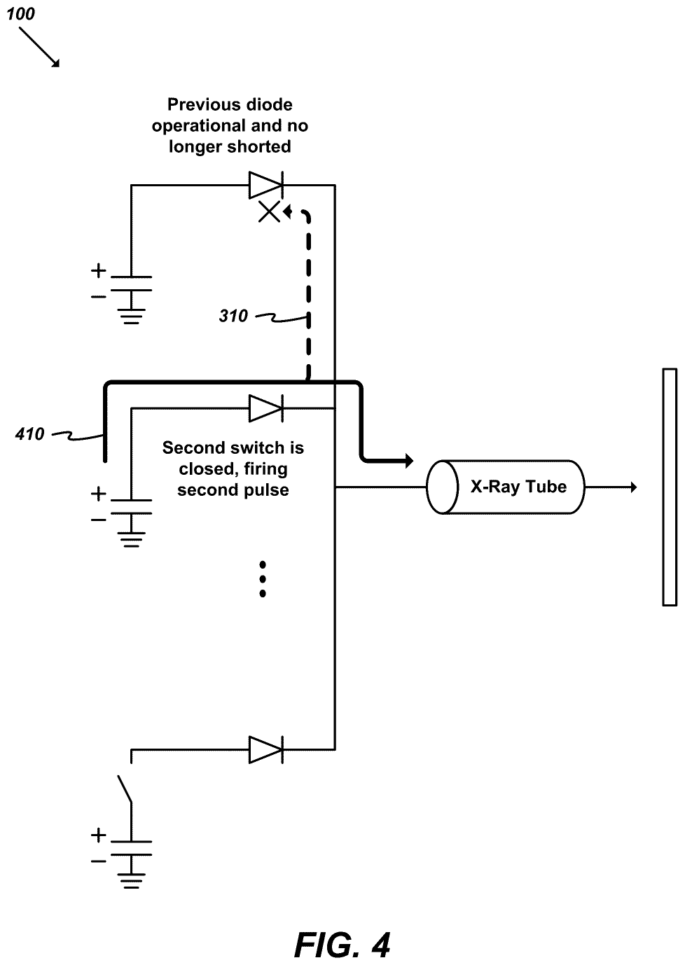

FIG. 4 illustrates an example overview of one or more embodiments described herein, in which a second X-ray pulse 110 of a multi-pulse X-ray is fired. In this example, a second pulse may be generated by the second pulse generator 170 from the top of the page and be supplied to the X-ray tube 120 via second pulse path 410 (including associated isolation diode 150). As shown, the second switch 140 may be closed, releasing the stored charge at the second capacitor 130, and a second pulse may be fired via the second isolation diode 150 and the X-ray tube 120, generating a second X-ray pulse 110.

Additional pulses may be generated in a similar manner, proceeding along the set of pulse generators 170. In this way, a serial sequence including multiple pulses may be generated via the pulse sequencer 100.

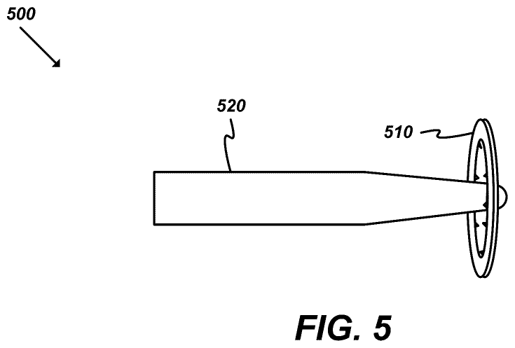

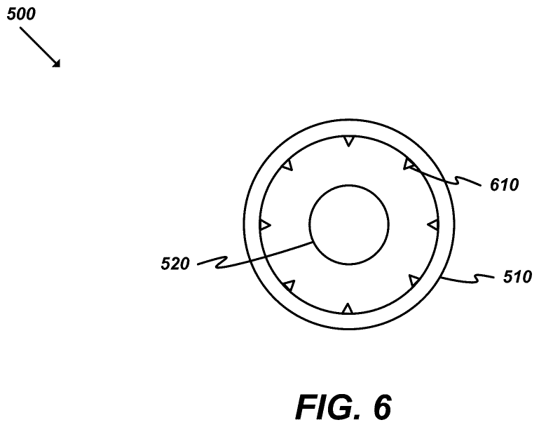

FIG. 5 illustrates a left side elevation view of an isolation diode 500 of one or more embodiments described herein. Isolation diode 500 may be one example embodiment of isolation diode 150. FIG. 6 illustrates a front elevation view of isolation diode 500. As shown, the isolation diode 500 may be a field emission effect diode that may include a cathode 510 and an anode 520. Concentration of field contours near the cathode 510 may optimize the operation of isolation diode 500. Such field concentration may be achieved by adding small spikes or other field enhancement features 610 near the surface of the cathode 510. Utilization of field enhancement assists to control flow of electrons in one direction across the isolation diode 500. Isolation diode 500 may have a same, or similar, structure as X-ray tube 120 in some embodiments.

In some embodiments, isolation diode 500 may be housed in a glass, metal, or plastic vacuum chamber. The components of isolation diode 500 may be sized, shaped, and/or arranged in various different ways, as appropriate.

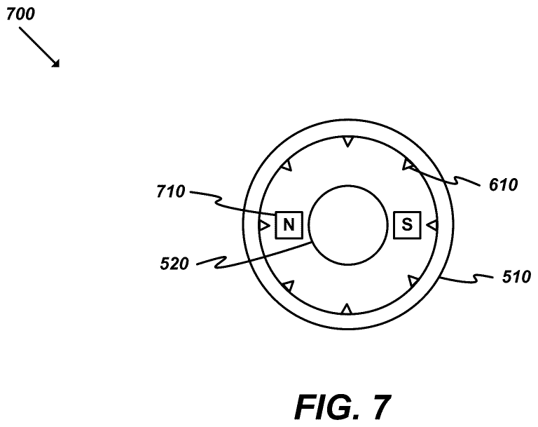

FIG. 7 illustrates a front elevation view of an isolation diode 700 of one or more embodiments described herein. Isolation diode 700 may be one example embodiment of isolation diode 150. Isolation diode 700 may be similar to isolation diode 500 and may include one or more magnets 710 and/or other plasma removal features. Each magnet 710 may be, include, or utilize, a set of one or more permanent magnets and/or a set of one or more electromagnets.

The magnets 710 may be arranged as shown, between the anode 520 and cathode 510. The magnets 710 may also be arranged in alternate configurations to suppress plasma influence either by locally containing the plasma, sweeping the plasma out of the way, or by enhancing plasma recombination to neutralize the plasma. Some embodiments of isolation diode 700 may be housed in a cylindrical metal tube, where the anode 520 has a cylindrical shape, the cathode 510 has an annular shape, and the magnets 710 may be arranged in a ring pattern, or have an annular shape, where the magnets 710 may be located between the anode 520 and cathode 510.

In some embodiments, other features and/or components may be used to clear plasma from the isolation diodes 700 or 500. For instance, a housing of isolation diode 700 may be filled with a gas having a high electronic affinity to reduce clear time. As another example, isolation diode 700 may be cooled such that plasma recombines more quickly. As another example, variations in air flow, use of inert gases, and/or pressure variations may reduce time to clear the plasma. As another example, in some embodiments, the anode may be encapsulated in polyimide tape to reduce or stop ion flow.

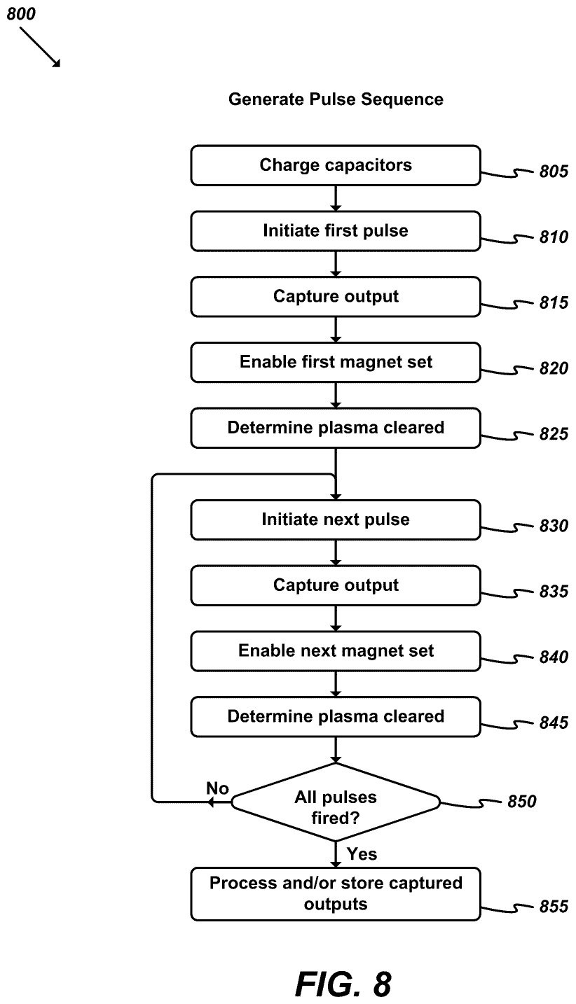

FIG. 8 illustrates an example process 800 for generating a sequence of pulses. The process may be used to generate a multi-pulse X-ray image. The process may be performed when an X-ray image, or set of images, is captured. In some embodiments, process 800 may be performed by a device such as pulse sequencer 100.

As shown, process 800 may include charging (at 805) capacitors, such as capacitors 130. As described above, capacitors 130 may include or utilize Marx generators that may be charged in various appropriate ways.

Process 800 may include initiating (at 810) a first pulse. As described above, a first pulse may be generated, for example, by closing a switch, such as switch 140, associated with a pulse generator such as pulse generator 170.

The process may include capturing (at 815) an output. Capturing the output may include, for instance, receiving data from X-ray detector 160. Such data may be used to generate one or more images or X-rays. Such images or X-rays may be stored to memory for later use and/or analysis.

The process may include enabling (at 820) a first magnet set. A set of magnets, such as magnet 710 may be enabled in various appropriate ways, depending on various relevant factors, such as the type of magnet, type of isolation diode, etc. For instance, permanent magnets may always be active and may not need to be enabled. As another example, power may be applied to activate an electromagnet.

As shown, process 800 may include determining (at 825) that plasma has cleared form the first isolation diode. Such a determination may be made in various appropriate ways. For instance, in some embodiments, a timer or similar resource may be used to determine when plasma has cleared. For example, experimental data may show that plasma clears within one millisecond with no intervention and within ten microseconds when a magnetic field is applied. As another example, some embodiments of the pulse sequencer 100 may include various sensors that may be able to determine when plasma has cleared (e.g., based on captured image data, based on measured conductivity, etc.).

Process 800 may include initiating (at 830) a next pulse. Once the process determines that the plasma has cleared, the process may initiate a next pulse by closing a next switch 140 to release the stored energy of the next capacitor 130.

The process may include capturing (at 835) the output. Capturing the output may include, for instance, receiving data from X-ray detector 160. Such data may be used to generate one or more images or X-rays. Such images or X-rays may be stored to memory for later use and/or analysis.

The process may include enabling (at 840) a next magnet set. A magnet set 710 associated with the next isolation diode 150 may be enabled and/or utilized to clear plasma.

As shown, process 800 may include determining (at 845) that plasma has cleared from the next isolation diode. Such a determination may be made in a similar way as operation 840 described above.

Process 800 may include determining (at 850) whether all pulses have been fired. The total number of pulses may depend on various relevant factors, such as number of available pulse generators 170, number of desired pulses, type of X-ray detector 160, and/or other relevant factors.

If the process determines (at 850) that all pulses have not been fired, the process may repeat operations 830-850 until the process determines (at 850) that all pulses have been fired.

If process 800 determines (at 850) that all pulses have been fired, the process may include processing and/or storing (at 855) the captured outputs. For example, such data may be used to generate one or more images or X-rays. Such images or X-rays may be stored to memory for later use and/or analysis.

One of ordinary skill in the art will recognize that process 800 may be implemented in various different ways without departing from the scope of the disclosure. For instance, the elements may be implemented in a different order than shown. As another example, some embodiments may include additional elements or omit various listed elements. Elements or sets of elements may be performed iteratively and/or based on satisfaction of some performance criteria. Non-dependent elements may be performed in parallel. Elements or sets of elements may be performed continuously and/or at regular intervals.

The processes and modules described above may be at least partially implemented as software processes that may be specified as one or more sets of instructions recorded on a non-transitory storage medium. These instructions may be executed by one or more computational element(s) (e.g., microprocessors, microcontrollers, digital signal processors (DSPs), application-specific integrated circuits (ASICs), field programmable gate arrays (FPGAs), other processors, etc.) that may be included in various appropriate devices in order to perform actions specified by the instructions.

As used herein, the terms “computer-readable medium” and “non-transitory storage medium” are entirely restricted to tangible, physical objects that store information in a form that is readable by electronic devices.

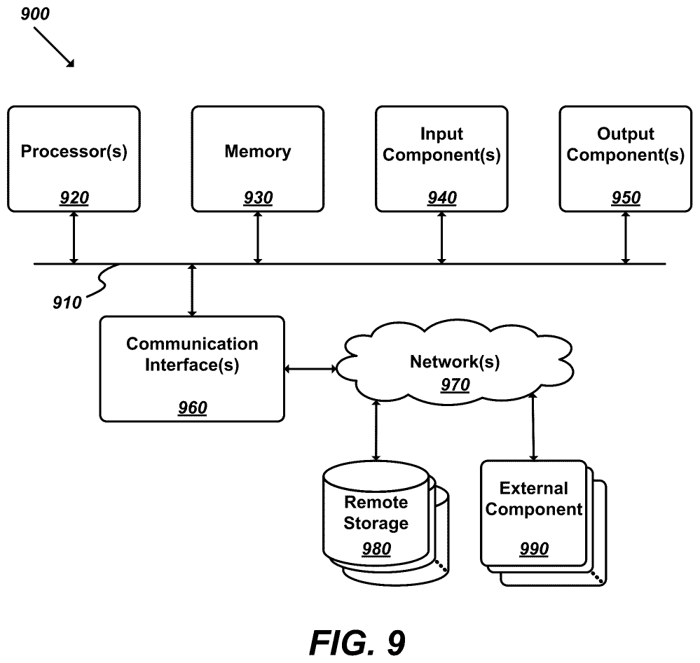

FIG. 9 illustrates a schematic block diagram of an exemplary device (or system or devices) 900 used to implement some embodiments. For example, the systems, devices, components, and/or operations described above in reference to FIG. 1, FIG. 2, FIG. 3, FIG. 4, FIG. 5, FIG. 6, and FIG. 7 may be at least partially implemented using device 900. As another example, the process described in reference to FIG. 8 may be at least partially implemented using device 900.

Device 900 may be implemented using various appropriate elements and/or sub-devices. For instance, device 900 may be implemented using one or more personal computers (PCs), servers, mobile devices (e.g., smartphones), tablet devices, wearable devices, and/or any other appropriate devices. The various devices may work alone (e.g., device 900 may be implemented as a single smartphone) or in conjunction (e.g., some components of the device 900 may be provided by a mobile device while other components are provided by a server).

As shown, device 900 may include at least one communication bus 910, one or more processors 920, memory 930, input components 940, output components 950, and one or more communication interfaces 960.

Bus 910 may include various communication pathways that allow communication among the components of device 900. Processor 920 may include a processor, microprocessor, microcontroller, DSP, logic circuitry, and/or other appropriate processing components that may be able to interpret and execute instructions and/or otherwise manipulate data. Memory 930 may include dynamic and/or non-volatile memory structures and/or devices that may store data and/or instructions for use by other components of device 900. Such a memory device 930 may include space within a single physical memory device or spread across multiple physical memory devices.

Input components 940 may include elements that allow a user to communicate information to the computer system and/or manipulate various operations of the system. The input components may include keyboards, cursor control devices, audio input devices and/or video input devices, touchscreens, motion sensors, etc. Output components 950 may include displays, touchscreens, audio elements such as speakers, indicators such as light-emitting diodes (LEDs), printers, haptic or other sensory elements, etc. Some or all of the input and/or output components may be wirelessly or optically connected to the device 900.

Device 900 may include one or more communication interfaces 960 that are able to connect to one or more networks 970 or other communication pathways. For example, device 900 may be coupled to a web server on the Internet such that a web browser executing on device 900 may interact with the web server as a user interacts with an interface that operates in the web browser. Device 900 may be able to access one or more remote storages 980 and one or more external components 990 through the communication interface 960 and network 970. The communication interface(s) 960 may include one or more application programming interfaces (APIs) that may allow the device 900 to access remote systems and/or storages and also may allow remote systems and/or storages to access device 900 (or elements thereof).

It should be recognized by one of ordinary skill in the art that any or all of the components of computer system 900 may be used in conjunction with some embodiments. Moreover, one of ordinary skill in the art will appreciate that many other system configurations may also be used in conjunction with some embodiments or components of some embodiments.

In addition, while the examples shown may illustrate many individual modules as separate elements, one of ordinary skill in the art would recognize that these modules may be combined into a single functional block or element. One of ordinary skill in the art would also recognize that a single module may be divided into multiple modules.

Device 900 may perform various operations in response to processor 920 executing software instructions stored in a computer-readable medium, such as memory 930. Such operations may include manipulations of the output components 950 (e.g., display of information, haptic feedback, audio outputs, etc.), communication interface 960 (e.g., establishing a communication channel with another device or component, sending and/or receiving sets of messages, etc.), and/or other components of device 900.

The software instructions may be read into memory 930 from another computer-readable medium or from another device. The software instructions stored in memory 930 may cause processor 920 to perform processes described herein. Alternatively, hardwired circuitry and/or dedicated components (e.g., logic circuitry, ASICs, FPGAs, etc.) may be used in place of or in combination with software instructions to implement processes described herein. Thus, implementations described herein are not limited to any specific combination of hardware circuitry and software.

The actual software code or specialized control hardware used to implement an embodiment is not limiting of the embodiment. Thus, the operation and behavior of the embodiment has been described without reference to the specific software code, it being understood that software and control hardware may be implemented based on the description herein.

While certain connections or devices are shown, in practice additional, fewer, or different connections or devices may be used. Furthermore, while various devices and networks are shown separately, in practice the functionality of multiple devices may be provided by a single device or the functionality of one device may be provided by multiple devices. In addition, multiple instantiations of the illustrated networks may be included in a single network, or a particular network may include multiple networks. While some devices are shown as communicating with a network, some such devices may be incorporated, in whole or in part, as a part of the network.

Some implementations are described herein in conjunction with thresholds. To the extent that the term “greater than” (or similar terms) is used herein to describe a relationship of a value to a threshold, it is to be understood that the term “greater than or equal to” (or similar terms) could be similarly contemplated, even if not explicitly stated. Similarly, to the extent that the term “less than” (or similar terms) is used herein to describe a relationship of a value to a threshold, it is to be understood that the term “less than or equal to” (or similar terms) could be similarly contemplated, even if not explicitly stated. Further, the term “satisfying,” when used in relation to a threshold, may refer to “being greater than a threshold,” “being greater than or equal to a threshold,” “being less than a threshold,” “being less than or equal to a threshold,” or other similar terms, depending on the appropriate context.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

The foregoing relates to illustrative details of exemplary embodiments and modifications may be made without departing from the scope of the disclosure. Even though particular combinations of features are recited in the claims and/or disclosed in the specification, these combinations are not intended to limit the possible implementations of the disclosure. In fact, many of these features may be combined in ways not specifically recited in the claims and/or disclosed in the specification. For instance, although each dependent claim listed below may directly depend on only one other claim, the disclosure of the possible implementations includes each dependent claim in combination with every other claim in the claim set.

We claim:

1. A multi-pulse X-ray device comprising:
an X-ray tube;
a plurality of pulse generators arranged in parallel, wherein an output of each pulse generator from the plurality of pulse generators is coupled to an input of an isolation diode from an associated plurality of isolation diodes;
wherein each output of each isolation diode from the plurality of isolation diodes is coupled to an input of the X-ray tube; and
an X-ray detector arranged to capture at least a portion of the X-ray radiation emitted by the X-ray tube.

2. The multi-pulse X-ray device of claim 1, wherein each pulse generator in the plurality of pulse generators comprises:
a capacitive source; and
a switch coupled to the capacitive source.

3. The multi-pulse X-ray device of claim 2, wherein the capacitive source comprises a Marx generator.

4. The multi-pulse X-ray device of claim 2, wherein the isolation diode is an X-ray tube.

5. The multi-pulse X-ray device of claim 2, wherein the isolation diode comprises:
an anode;
a cathode; and
a set of magnets arranged between the anode and the cathode.

6. The multi-pulse X-ray device of claim 5, wherein the set of magnets comprises an electromagnet.

7. The multi-pulse X-ray device of claim 5, wherein the isolation diode further comprises a set of field enhancement features arranged near a surface of the cathode.

8. A pulse sequencer for a multi-pulse X-ray, the pulse sequencer comprising:
an X-ray tube; and
a plurality of pulse generators arranged in parallel, wherein an output of each pulse generator from the plurality of pulse generators is coupled to an input of an isolation diode from an associated plurality of isolation diodes, wherein each output of each isolation diode from the plurality of isolation diodes is coupled to an input of the X-ray tube.

9. The pulse sequencer of claim 8, wherein each pulse generator in the plurality of pulse generators comprises:
a capacitive source;
a switch coupled to the capacitive source; and
an isolation diode coupled to the switch.

10. The pulse sequencer of claim 9, wherein the capacitive source comprises a Marx generator.

11. The pulse sequencer of claim 9, wherein the isolation diode is an X-ray tube.

12. The pulse sequencer of claim 9, wherein the isolation diode comprises:
an anode;
a cathode; and
a set of magnets arranged between the anode and the cathode.

13. The pulse sequencer of claim 12, wherein the set of magnets comprises one or more electromagnets.

14. The pulse sequencer of claim 12, wherein the isolation diode further comprises a set of field enhancement features arranged near a surface of the cathode.

15. A method comprising:
charging a set of capacitive sources;
initiating, via a first isolation diode, a first pulse to an X-ray tube; and
enabling a first set of magnets associated with the first isolation diode.

16. The method of claim 15 further comprising determining that the first isolation diode has regained functionality.

17. The method of claim 16 further comprising:
initiating, via a second isolation diode, a second pulse to an X-ray tube; and
enabling a second set of magnets associated with the second isolation diode.

18. The method of claim 17 further comprising determining that the second isolation diode has regained functionality.

19. The method of claim 18 further comprising, iteratively,
initiating, via a next isolation diode, a next pulse to an X-ray tube; and
enabling a next set of magnets associated with the next isolation diode.

20. The method of claim 19 further comprising determining that the next isolation diode has regained functionality.
